(19) United States
(12) Patent Application Publication
(10) Pub. No.: US 2025/0215941 A1
(43) Pub. Date: Jul. 3, 2025

(54) BRAKE CALIPER OF THE FLOATING TYPE OF A DISC BRAKE

(71) Applicant: Brembo S.p.A., Curno (IT)

(72) Inventors: Cristian CRIPPA, Curno (IT); Lorenzo NESSI, Curno (IT)

(21) Appl. No.: 19/001,764

(22) Filed: Dec. 26, 2024

(30) Foreign Application Priority Data
Dec. 28, 2023 (IT) 102023000028182

(51) Int. Cl. F16D 55/227; F16D 55/00; F16D 65/00; F16D 65/097; F16D 65/18; F16D 127/02

(52) U.S. Cl. CPC F16D 55/227; F16D 65/0056; F16D 65/0068; F16D 65/0087; F16D 65/097; F16D 2055/0008; F16D 2055/0016; F16D 2055/0066; F16D 2055/0091; F16D 65/183; F16D 2127/02

(57) ABSTRACT

The present invention relates to a brake caliper (1) of the floating type of a disc brake (100) comprising:

a bracket or support element (2) configured to be connected to a vehicle,

a caliper body or floating element (3),

wherein the caliper body (3) comprises a first caliper body portion or caliper body vehicle-side portion (3.1), wherein the first caliper body portion (3.1) delimits at least one housing seat (5) for thrust means (5a);

wherein the caliper body (3) comprises a second caliper body portion or cantilevered caliper body portion (3.2), wherein the second caliper body portion (3.2) projects from the first caliper body portion (3.1) at least in the axial direction (A-A);

at least one caliper body sliding guide or caliper body guide pin (11), wherein said at least one caliper body sliding guide (11) is arranged between said caliper body (3) and said bracket (2) to allow a relative sliding between the caliper body (3) and the bracket (2) along an axial direction (A-A);

at least two pads (6) having a support plate (7) and a friction material lining (8), each of said at least two pads (6) being positionable on a side of a brake disc (4) of said disc brake (100) facing opposite braking surfaces (4a) of a braking band (4b) of the brake disc (4);

said brake disc (4) being a rotor adapted to rotate about a rotation axis (10) which defines said axial direction (A-A), parallel to said rotation axis (10), a radial direction (R-R), orthogonal to said rotation axis (10), and a circumferential direction (C-C) orthogonal to said radial (R-R) and axial (A-A) directions;

at least one pad guide pin (12) supported by said bracket (2) and which extends in the axial direction (A-A), said pads (6) being slidingly mounted to said pad guide pin (12) so as to allow said pads (6) to slide in the axial direction (A-A) along said pad guide pin (12);

at least one spring (15), shaped to be arranged straddling the brake disc (4), wherein said spring (15) applies an elastic bias to the pads (6) so as to elastically bias the pads (6) away from the brake disc (4) and so as to cause, by means of at least one of said pads (6), the caliper body (3) to slide in said axial direction (A-A), in the direction in which the second caliper body portion (3.2) moves away from the brake disc (4);

wherein said spring (15) is also connected to said pad guide pin (12) in addition to being connected to said pads (6).

### FIELD OF THE INVENTION

The present invention relates to a floating brake caliper as well as to a disc brake comprising such a caliper.

### PRIOR ART

In a floating caliper disc brake, the brake caliper is typically arranged straddling the outer peripheral margin of a brake disc. The brake caliper usually comprises a body having two elongated elements, or portions, which are arranged so as to face opposite braking surfaces of a disc. Friction pads are provided arranged between each elongated element of the caliper and the braking surfaces of the brake disc. At least one of the elongated elements of the caliper body has at least one actuator, e.g., a cylinder adapted to accommodate a hydraulic piston capable of applying a thrust action to the pads, abutting them against the braking surfaces of the disc to apply a braking action to the vehicle.

The brake calipers are usually constrained to a support structure, which remains firmly connected to the vehicle, such as a suspension of a vehicle, more particularly a fork or swingarm of the suspension in the case of a motorcycle, for example.

In a typical arrangement, one of the two elongated elements has two or more attachment portions for attaching the caliper body to the support structure, for example by providing slots or eyelets, e.g., arranged axially, or through holes, e.g., arranged radially, adapted to receive screws for fixing the caliper, which are accommodated with the ends thereof in threaded holes provided on the caliper support.

In a typical caliper body construction, the elongated elements arranged facing the braking surfaces of the disc are mutually connected by bridge-like elements arranged straddling the disc.

In particular, a service and/or parking disc brake comprises a brake disc which rotates together with a wheel of a vehicle. Brake pads face the brake disc and are accommodated in a brake caliper placed straddling said brake disc. The pads are biased either directly or indirectly to abut against the opposite braking surfaces of the brake disc by actuation means of various types, including hydraulic means or, especially in the case of parking brakes, lever means.

In particular, in a floating caliper disc brake, the brake pad on one side, usually the side facing the vehicle, is displaced with respect to the caliper because it is biased by thrust means, e.g., a piston housed in the caliper body, and biased by brake fluid pressurized by the command of the vehicle driver, towards the disc.

The brake pad on the other side of the disc, e.g., the side facing the vehicle wheel, is typically fixed with respect to the caliper. In order to provide a clamping force on both sides of the disc, the caliper body moves axially with respect to the brake disc when the brake is actuated, to take the brake pad, which is fixed to the caliper, into contact with the brake disc. The caliper body also moves axially with respect to the brake disc to allow for pad and disc wear. Such a disc brake is known, for example, from U.S. Pat. No. 4,685,686, as well as from EP3633224, JP2017214962, JP2019128023, WO2020189356.

To allow this, the caliper is typically mounted on a brake carrier or brake support or bracket by means of two guide pins.

In a typical caliper construction, the bracket defines a sliding system for the pads, equipped with sliding springs, which resists braking torque. Such a sliding system has the drawback of requiring a relatively large number of components and processes to be manufactured. The typical structure of the pad sliding system defined in the bracket is also relatively heavy.

A further drawback of the known calipers is related to the fact that the caliper body, due to its geometry globally having a substantially “U-shaped” conformation, also referred to as a “fist-shaped” conformation, is subject to high deformability and is also difficult to customize aesthetically, except by adding aesthetic plates, which are usually coupled on the side of the caliper body exposed to view during use. The application of the aforesaid aesthetic plates has the drawback of requiring the development of ad hoc coupling means for coupling them to the caliper body.

In brake calipers, it is known to provide disc brake springs consisting of a central portion and two end portions, where the end portions rest against the pads so as to bias the pads elastically away from each other to ensure a separation of the pads from the brake disc after each braking action.

The known springs are normally used to obtain a three-fold effect:
reducing the vibrations of the pads;
moving the pads away from the brake disc to reduce or eliminate a residual braking torque (residual torque) due to undesired contacts between the pads and the brake disc with the brake deactivated;
obtaining uniform wear of the friction linings of the pads.

Usually, the known springs are kept in their operating position by fixing the central portion of the springs to the caliper body.

In particular, the springs of the prior art generally comprise one or more connection legs, formed at the central portion of the spring, adapted to connect the spring to the caliper at coupling portions formed on the caliper body.

A drawback of these known solutions in which the springs are connected to the caliper body or pads is due to the fact that such solutions fail to ensure a proper centering of the caliper body with respect to the braking band of the brake disc at the end of the braking action, which results in negative effects in terms of residual torque.

### OBJECT OF THE PRESENT INVENTION

It is a general object of the present invention to provide a solution which allows solving or obviating at least partially the drawbacks described above with reference to brake calipers of the prior rt.

Additionally or alternatively to the aforesaid object, it is a particular object of the present invention to provide a solution which allows improving the performance of the brake caliper in terms of residual torque, in particular at the end of the braking action.

Additionally or alternatively to the aforesaid objects, it is a particular object of the present invention to provide a solution which allows improving the robustness of the brake caliper by allowing the deformability of the caliper body to be reduced compared to solutions of the prior art, preferably by also improving the aesthetics of the caliper itself.

Additionally or alternatively to the aforesaid objects, it is a particular object of the present to provide a solution which allows reducing the number of components and/or the number of processes required for manufacturing the brake caliper and particularly the related pad sliding system.

Additionally or alternatively to the aforesaid objects, it is a particular object of the present invention to provide a solution which allows reducing the weight of the brake caliper.

Additionally or alternatively to the aforesaid objects, it is a particular object of the present to provide a solution which allows processing the seats for the thrust means of the caliper with standard tools and without the aid of angled tools which would increase the processing difficulty and time, while simultaneously reducing the perimeter of applicability.

These and other objects are achieved by a brake caliper as defined in appended claim 1 in the most general form thereof and in the dependent claims in several particular embodiments. The present invention also relates to a brake disc as defined in claim 15.

### DRAWINGS

In order to better understand the invention and appreciate the advantages thereof, some non-limiting exemplary embodiments thereof will be described below with reference to the accompanying drawings, in which:

FIG. 1 is a perspective view of a floating brake caliper according to an embodiment of the invention;

FIG. 2 is a further perspective view of the caliper in FIG. 1;

FIG. 3 is a top plan view of the caliper in FIG. 1;

FIG. 4 is a bottom plan view of the caliper in FIG. 1;

FIG. 5 is a front plan view of the brake caliper in FIG. 1;

FIG. 6 is a perspective view of the caliper body of the brake caliper in FIG. 1;

FIG. 7 is a side plan view of the brake caliper in FIG. 1;

FIG. 8 is a cross-section plan view of the brake caliper according to line Q-Q in FIG. 5;

FIG. 9 is a plan view of a disc brake comprising the brake caliper in FIG. 1, in which a cross-section of the brake caliper is shown according to line P-P in FIG. 5, and in which a braking band of the brake disc of the disc brake is diagrammatically and partially depicted;

FIG. 10 is an enlarged detail of FIG. 9;

FIG. 11 is a perspective view of a spring of the brake caliper in FIG. 1;

FIG. 12 is a side plan view of the spring in FIG. 11;

FIG. 13 is a bottom perspective view of a part of the brake caliper in FIG. 1 in which the spring in FIG. 11 is shown mounted in the brake caliper;

FIG. 14 is a front plan view of a pad of the brake caliper in FIG. 1;

FIG. 15 is a perspective view of a support element or bracket of the brake caliper in FIG. 1;

FIG. 16 is a perspective view of a guide pin of the pads of the brake caliper in FIG. 1 and of a sliding guide of the caliper body in FIG. 6 coupled together;

FIG. 17 is a perspective view of the pad guide pin shown in FIG. 16;

FIG. 18 is a perspective view of the caliper body sliding guide shown in FIG. 16.

### DETAILED DESCRIPTION OF SOME EMBODIMENTS OF THE INVENTION

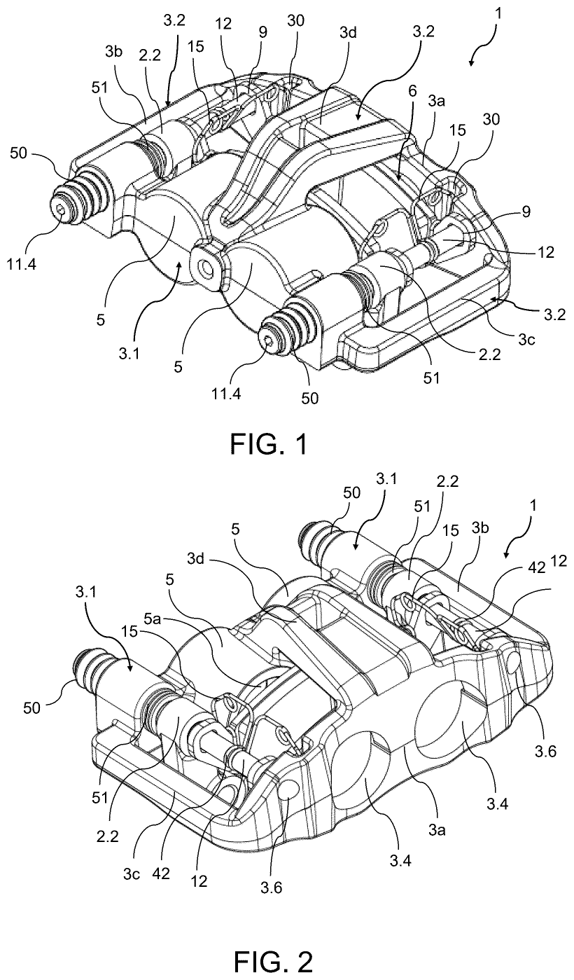

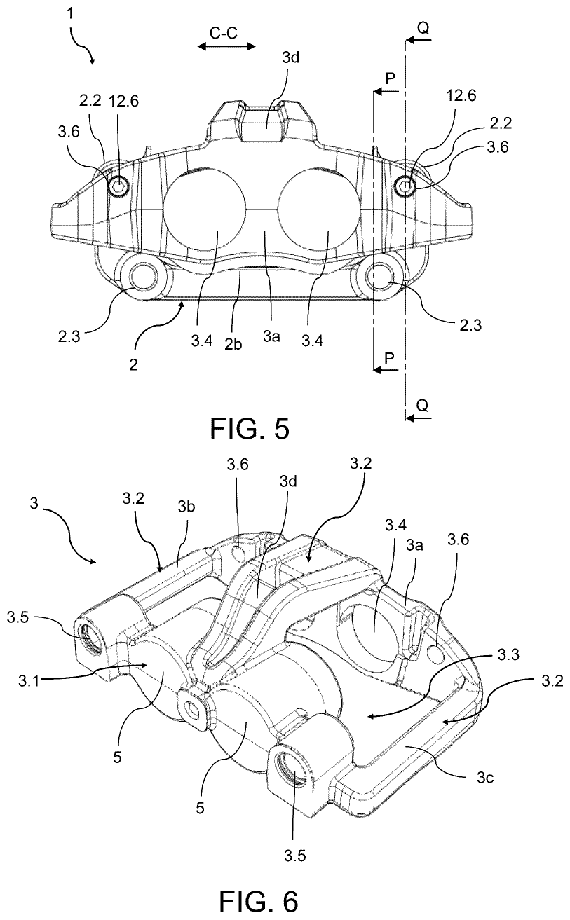

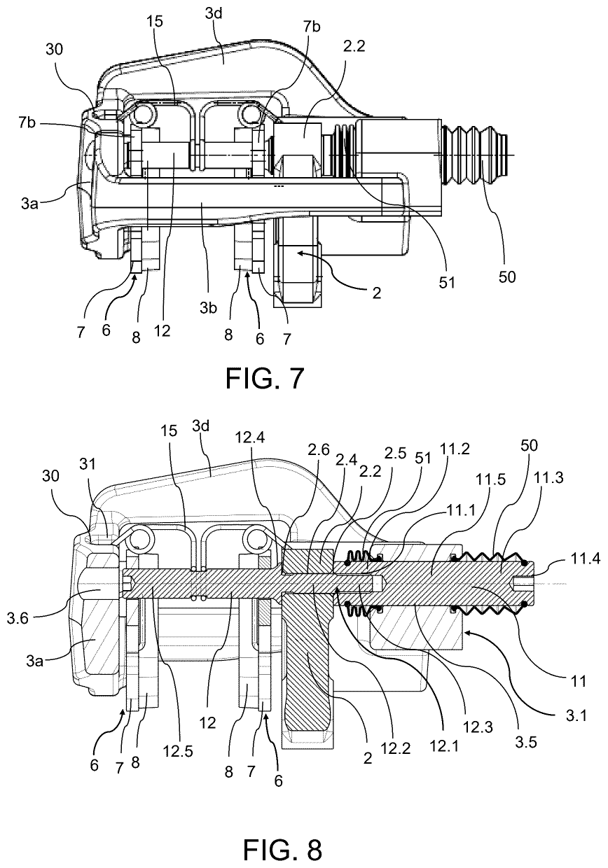

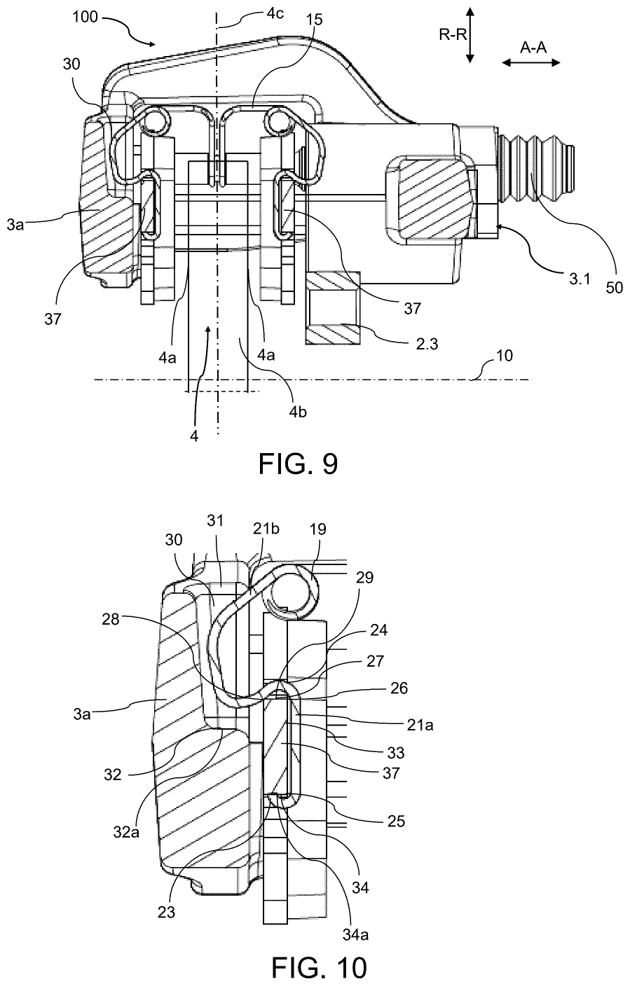

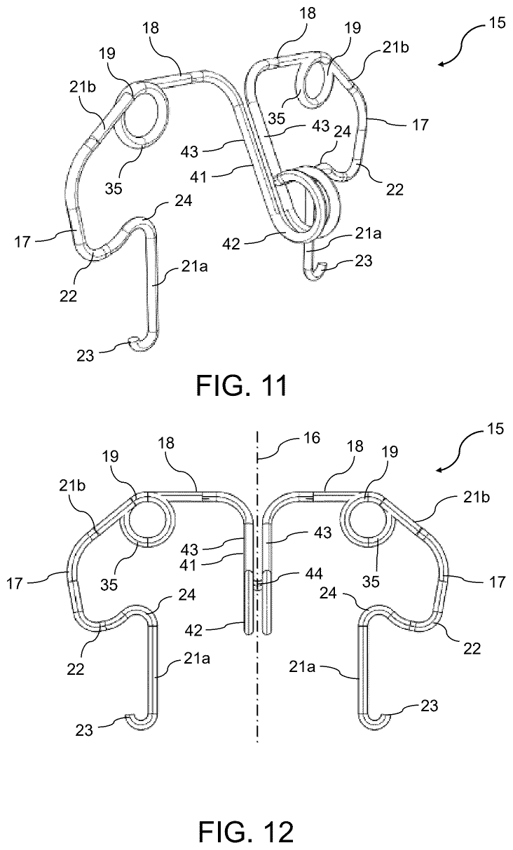

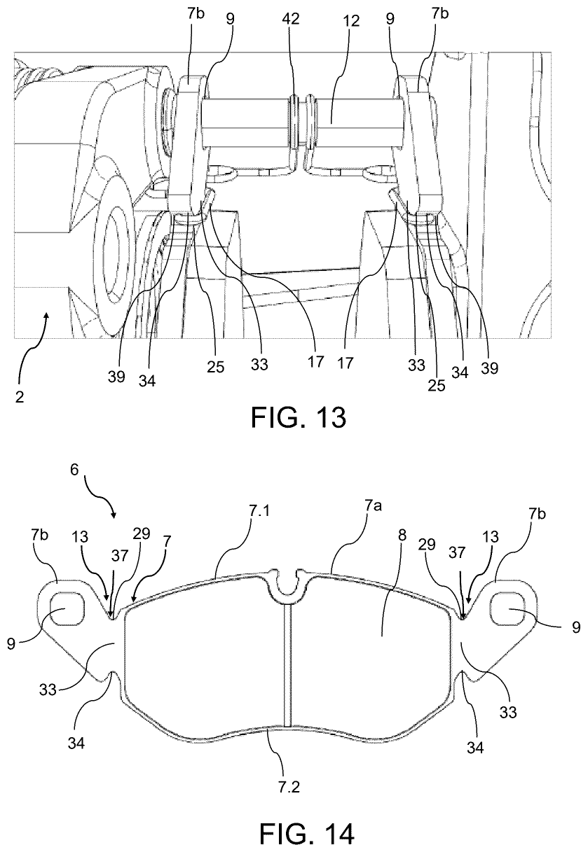

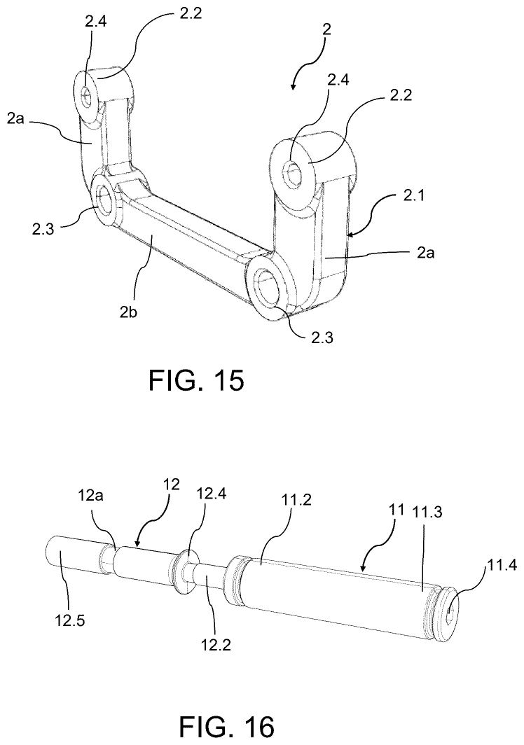

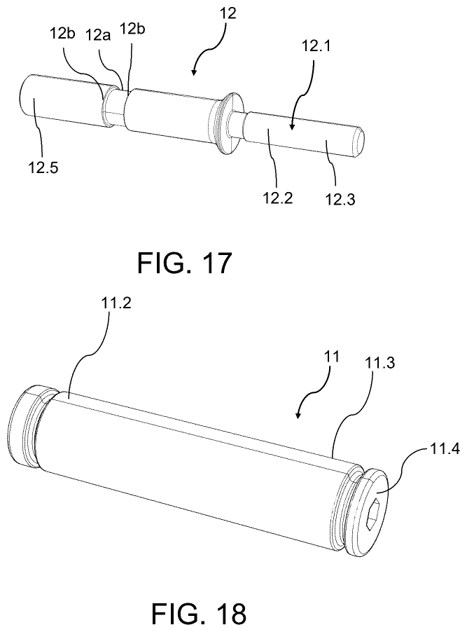

With reference to the FIGS. 1 through 18, a disc brake, in particular for use on motor vehicles, is indicated by reference numeral 100 as a whole. Specifically, it is a disc brake of the floating caliper type.

The disc brake 100 comprises a floating brake caliper 1 and a brake disc 4, where the brake disc 4 defines a rotation axis 10. The caliper 1 comprises a bracket or support element or support of the brake 2 configured to be connected to a vehicle and a caliper body or floating element 3. According to an embodiment, the bracket 2 is fixed to a vehicle suspension, while the brake disc 4, provided with an annular braking band, is connectable to the wheel hub of the vehicle (not shown).

The brake disc 4 is a rotor adapted to rotate about a rotation axis 10 which defines an axial direction A-A, parallel to the rotation axis 10, a radial direction R-R, orthogonal to the rotation axis 10, and a circumferential direction C-C, orthogonal to the axial A-A and radial R-R directions. According to an embodiment, the rotation axis 10 further defines a tangential direction T-T punctually orthogonal to a radial direction R-R and a circumferential direction C-C at the point of intersection thereof.

According to an embodiment, the caliper body 3 comprises a first caliper portion or caliper body vehicle-side portion 3.1. The first caliper body portion 3.1 delimits at least one housing seat 5 for thrust means 5a. According to an embodiment, the thrust means 5a comprise at least one actuator 5a, such as a hydraulic cylinder-piston assembly 5a, for example, housed in the at least one seat 5. According to an embodiment, the first caliper body portion 3.1 delimits two housing seats 5, in which the aforesaid thrust means 5a are housed.

According to an embodiment, the caliper body 3 further comprises a second caliper body portion or cantilevered caliper body portion 3.2, where the second caliper body portion 3.2 projects from the first caliper body portion 3.1 at least in the axial direction A-A. In particular, according to an embodiment, the second caliper body portion 3.2 projects from the first caliper body portion 3.1 at least in the axial direction A-A on a side opposite to the vehicle. According to an embodiment, the first caliper body portion 3.1 and the second caliper body portion 3.2 are arranged to face opposite braking surfaces 4a of a brake disc 4.

According to an embodiment, the second caliper body portion 3.2 comprises a first part 3a, a second part 3b, and a third part 3c of the second caliper body portion 3.2. The first part 3a of the second caliper body portion 3.2 is opposed to and distanced in the axial direction A-A from the first caliper body portion 3.1. According to an embodiment, the first caliper body portion 3.1 and the first part 3a of the second caliper body portion 3.2 are arranged to face opposite braking surfaces of the brake disc 4. The second part 3b and the third part 3c of the second caliper body portion 3.2 are mutually opposed and extend at least in the axial direction A-A to connect the first caliper body portion 3.1 and the first part 3a of the second caliper body portion 3.2. The first caliper body portion 3.1 and the aforesaid first part 3a, second part 3b, and third part 3c of the second caliper body portion 3.2 are joined together so as to form a closed ring, which extends about or delimits a housing space 3.3 of the pads 6 of the caliper 1. In practice, according to an embodiment, the first caliper body portion 3.1 and the aforesaid first part 3a, second part 3b, and third part 3c of the second caliper body portion 3.2 are joined together so as to form a part of the caliper body 3, which is substantially frame-shaped, where the first caliper body portion 3.1 and the aforesaid first part 3a, second part 3b, and third part 3c of the second caliper body portion 3.2 each correspond to a frame side of the frame-shaped part of the caliper body 3. Advantageously, such a conformation of the caliper body 3 allows significantly improving the stiffness of the caliper body by reducing the deformations thereof under the operating conditions of the caliper 1. Furthermore, such a conformation of the caliper body 3 allows improving the aesthetics of the caliper body 3. Indeed, the frame-shaped part of the caliper body 3 not only makes the design of the caliper body more aesthetically pleasing, but also allows shaping the first part 3a of the caliper body so as to make more space available on which possible logos can be applied, e.g., by engraving them directly onto the caliper body and without the need to apply aesthetic plates.

According to an embodiment, the second caliper body portion 3.2 comprises a bridge-like connection portion 3d which connects the first caliper body portion 3.1 and the first part 3a of the second caliper body portion 3.2 so that the caliper body 3 is adapted to be arranged straddling the brake disc 4.

According to a preferred embodiment, the second caliper body portion 3.2 comprises a first part 3a of the second caliper body portion 3.2, which is opposed to and spaced apart in the axial direction A-A from the first caliper body portion 3.1. Furthermore, the second caliper body portion 3.2 comprises a bridge-like connection portion 3d, which connects the first caliper body portion 3.1 and the first part 3a of the second caliper body portion 3.2 so that the caliper body 3 is adapted to be arranged straddling the brake disc 4.

According to an embodiment, the first part 3a of the second caliper body portion 3.2 comprises at least one processing or front discharge through-opening 3.4 arranged facing the at least one housing seat 5 for the thrust means 5a, which is configured to be crossed by a tool to allow processing the inner surface of the at least one housing seat 5 for the thrust means 5a. According to an embodiment, the at least one opening 3.4 is a circle-shaped opening. According to an embodiment, the at least one opening 3.4 has a diameter corresponding to the diameter of a cylinder-piston assembly housed in the housing seat 5. According to an embodiment, the first part 3a comprises two processing through-openings 3.4. Advantageously, the presence of at least one processing through-opening 3.4 allows processing the at least one housing seat 5 using standard tools.

The caliper 1 comprises at least one caliper body sliding guide or caliper body guide pin 11. According to an embodiment, the caliper 1 comprises two caliper body sliding guides or caliper body guide pins 11, which are arranged on two opposite sides or two opposite side in the circumferential direction C-C, with respect to the pads 6, which will be described below in the present description. The at least one caliper body sliding guide 11 is arranged between the caliper body 3 and the bracket 2 to allow a relative sliding between the caliper body 3 and the bracket 2 along an axial direction A-A. In other words, the at least one brake caliper sliding guide 11 is supported, either directly or indirectly, by the bracket 2 to allow a relative sliding between the caliper body 3 and the bracket 2 along an axial direction A-A. According to an embodiment, which will be described below in the present description, the at least one caliper body sliding guide 11 is, for example, indirectly supported by the bracket 2 by means of the at least one pad guide pin 12.

The caliper 1 comprises at least two pads or clutch pads 6, each having a support plate 7, e.g., made of steel, and a friction material lining 8. Each of the at least two pad 6 is positionable on one side of brake disc 4 of the disc brake 100 so that they face opposite braking surfaces 4a of a braking band 4b of the brake disc 4.

According to a possible embodiment, the support plate 7 of each pad 6 is preferably substantially planar. According to an embodiment, the support plate 7 has a central portion 7a and preferably forms two ears 7b protruding outwards from the support plate 7. In particular, according to an embodiment, the two ears 7b extend outwards from the support plate 7 in the circumferential direction C-C. According to an embodiment, each of the ears 7b forms a coupling seat 13. According to an embodiment, each ear 7b forms and defines a coupling portion 37 of the support plate 7. The central portion 7a substantially preferably has the shape of a distorted rectangle. Such a central portion 7a has an upper edge 7.1 and a lower edge 7.2 opposed to the upper edge 7.1. Preferably, the upper edge 7.1 is substantially convex, while the lower edge 7.2 is substantially concave. According to an embodiment, each pad 6 comprises one or more eyelets 9, which are preferably obtained in the plate 7 outside the zone in which the friction material 8 is provided and more preferably in the ears 7b. Each eyelet 9 is intended to accommodate, preferably with clearance, a respective pad guide pin 12 of the caliper 1, which will be described in more detail below in the present description. According to a possible embodiment, each pad is provided with two such eyelets 9, and the brake caliper 1 is provided with two pins 12. According to an advantageous embodiment, the eyelets 9 are provided according to the solution described in the patent application published under number WO2010010583 to Freni Brembo S.p.A. Conveniently, such a geometry of the eyelets 9 allows preventing or at least limiting the noises generated by the pads 6 mutually hitting (clang noise).

According to an embodiment, the pads 6 are mounted suspended from the at least one pad guide pin 12. In other words, according to an embodiment, the lower edge 7.2 of the pads 6 is a free edge. In yet other words, according to an embodiment, the lower edge 7.2 of the pads 6 is not in contact or prevents coming into contact with other components of the caliper 1. In yet other words, according to an embodiment, each pad 6 is configured to slide exclusively along the at least one pad guide pin 12 and more preferably along two pad guide pins 12. According to an embodiment, the pads 6 are prevented from being fixed to the caliper body 3.

The pads 6 are mainly displaceable in the axial direction A-A (parallel to the rotation axis 10 of the brake disc 4), towards the brake disc 4, by the aforesaid thrust means 5a, so as to clamp, by means of the friction material 8, a sector of the braking band 4b, the surface and shape of which preferably corresponds to that of the friction material 8.

The caliper 1 comprises the aforesaid at least one pad guide pin 12 which is supported by the bracket 2. According to an embodiment, the pad guide pin 12 is supported either directly or indirectly by the bracket 2. According to an embodiment shown in the accompanying figures and which will be described in more detail below in the present description, the at least one guide pin 12 is directly supported by the bracket 2. The at least one pin 12 extends in the axial direction A-A. The pads 6 are slidingly mounted to the at least one pad guide pin 12 so as to allow the pads 6 to slide in the axial direction A-A along the pad guide pin 12. According to an embodiment, the pads 6 are slidingly mounted to two pad guide pins 12 so as to allow the pads 6 to slide in the axial direction A-A along the two pad guide pins 12.

The caliper 1 comprises at least one spring 15, shaped to be arranged straddling the disc brake 4. The spring 15 applies an elastic bias to the pads 6 so as to bias the pads 6 elastically away from the brake disc 4. Furthermore, the spring 15 applies an elastic bias to the pads 6 so as to bias, by means of at least one of the pads 6, a sliding of the caliper body 3 in said axial direction A-A, in the direction in which the second caliper body portion 3.2 moves away from the brake disc 4. Advantageously, the spring 15 is also connected to the at least one pad guide pin 12 in addition to the pads 6. According to an embodiment, in particular, the spring 15 is connected exclusively to the pads 6 and the pad guide pin 12. Indeed, by connecting the at least one spring 15 to a respective pad guide pin 12, it is advantageously possible to keep the spring 15 in a predetermined position with respect to a fixed element of the caliper 1, specifically the pad guide pin 12, so as to allow centering the pads 6, and therefore the caliper body 3, at the end of the braking action, in particular by means of the pad 6, arranged axially further away from the thrust means 5a, which pushes on the second portion 3.2 of the caliper body 3, respect to a centerline plane 4c of the brake disc 4, which is orthogonal to the rotation axis of the brake disc 4. In other words, according to an embodiment, upon releasing pressure on the brake disc 4, the spring 15 returns to the initial position, corresponding to a deactivated brake state, moving the pads 6 symmetrically away from the pad guide pin portion 12 to which it is fixed, ensuring the centering of pads 6 and caliper body 3 with respect to the brake disc 4.

According to an embodiment, the caliper 1 comprises two springs 15 adapted to be arranged straddling the brake disc 4 so as to bias the pads 6 elastically away from the brake disc 4. Each of the two springs 15 is configured to be directly connected exclusively to the pads 6 and a respective pad guide pin 12. According to an embodiment, the two springs 15 are connected to opposite sides of the two pads 6. According to an embodiment, each spring 15 is coupled or hooked in a removable manner to the pads 6 and a respective pad guide pin 12.

According to an embodiment, the at least one spring 15 is a single-piece wire spring. According to an embodiment, in particular, the spring 15 is a wire spring, e.g., made of a metal wire, e.g., steel, having a circular or rectangular section.

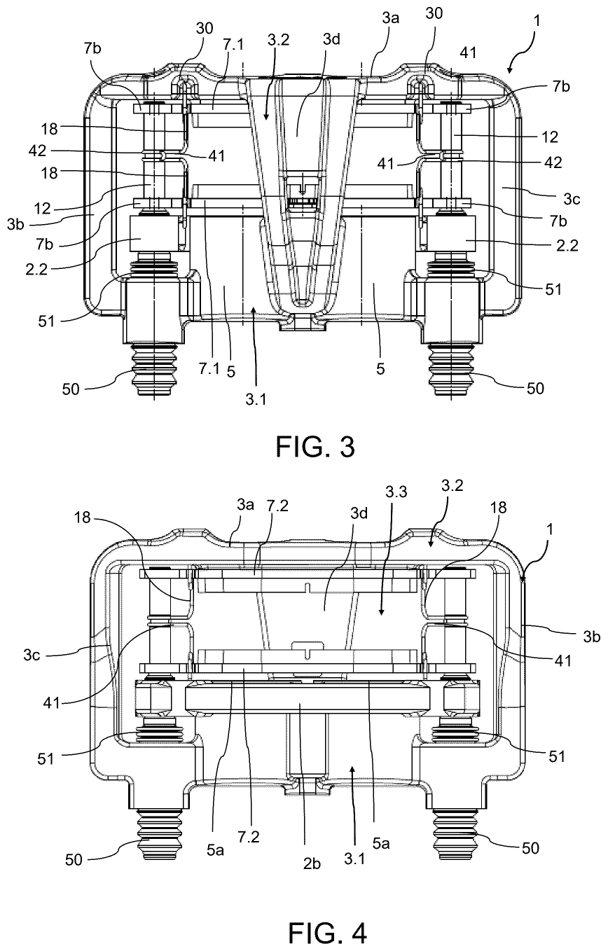

According to an embodiment, the pad guide pin 12 comprises a pin coupling seat 12a to which the spring 15 is connected. According to an embodiment, the pin coupling seat 12a is located at a predetermined portion of the pad guide pin 12 intended to be aligned or substantially aligned with a centerline plane 4c of the braking band 4b of the brake disc 4, which is orthogonal to said axial direction A-A or to the rotation axis 10 of the brake disc 4. According to an embodiment, the pin coupling seat 12a is located in a position in the axial direction A-A which is central with respect to the support plates of the two pads 6 when the pads 6 take an initial configuration corresponding to a deactivated brake state (e.g., FIG. 3 or FIG. 4).

According to an embodiment, the spring 15 defines a spring symmetry plane 16 and either comprises or consists of two side spring coupling portions or side spring arms 17 and a central spring coupling portion or central spring arm 41. According to an embodiment, the spring 15 is arranged so that the spring symmetry plane 16 either coincides or substantially coincides with the centerline plane 4c of the braking band 4b of the brake disc 4. The central portion 41 is interposed between the side spring coupling portions 17 and is connected to such side coupling portions 17. According to an embodiment, the central portion 41 is connected to the side portions 17 by means of a pair of connection portions 18 which preferably extend at least partially in the axial direction A-A. According to an embodiment, the central coupling portion 41 extends either mainly or entirely along a direction parallel to the spring symmetry plane 16. According to an embodiment, the side coupling portions or side spring arms 17 are configured to couple to a respective ear 7b of the two pads 6. According to an embodiment, the side coupling portions 17 are symmetrical with respect to the symmetry plane 16 and are configured to couple to two respective opposite plate coupling portions 37 of the pads 6.

According to an embodiment, each of the two side coupling portions or spring side arms 17 is connected to the central spring coupling portion by means of a respective connection portion 18 and/or by means of a first connection 19 having a spiral-shaped outline. According to an embodiment, the first connection 19 has a spiral-shaped outline with at least a first connection turn 35 forming an angle of at least 360 DEG.

According to an embodiment, each of the side coupling portions or side spring arms 17 is substantially “Z”-shaped or “S”-shaped, and each of the side coupling portions or side spring arms 17 comprises:
a first vertical portion or first radial portion 21a;
a second diagonal portion or second inclined portion 21b;
an indentation portion 22.

According to an embodiment, the second diagonal portion 21b is inclined with respect to first vertical portion 21a, and indentation portion 22 is interposed between the first vertical portion 21a and second diagonal portion 21b. According to an embodiment, the indentation portion 22 is substantially transverse to the first vertical portion 21a and the second diagonal portion 21b.

According to an embodiment, the indentation portion 22 is configured so as to lie on a respective coupling seat 13 of the ears 7b.

According to an embodiment, the first vertical portion 21a of each of the side coupling portions or side spring arms 17 is connected at a first end thereof to the indentation portion 22 by means of a second connection 24, where the second connection 24 is preferably shaped as a loop or an arc of circumference.

According to an embodiment, the second end of the vertical portion 21a is connected to a hook-shaped end portion 23.

According to an embodiment, the spring 15 is configured so that, in the operating position, the side coupling portions or side spring arms 17 are each interposed between the pads 6 and the brake disc 4.

According to an embodiment, the side coupling portions 17 of the spring 15 are shaped so as to exhibit only curvatures about axes substantially parallel to one another and substantially parallel to the symmetry plane 16 of the spring 15.

According to an embodiment, the spring 15 is elastically deformable by means of a relative movement of the coupling portions 17, where the coupling portions 17 are movable by the respective pads 6, with respect to the central spring coupling portion 41.

The central spring coupling portion 41 is configured to couple or connect to the pin coupling seat 12a.

According to an embodiment, the side coupling portions 17 are aligned or substantially aligned in the axial direction A-A, and the central spring coupling portion 41 is an inclined portion which projects in the circumferential direction C-C with respect to the side coupling portions 17 to couple to or hook to the coupling seat 12a.

According to an embodiment, the central spring coupling portion 41 comprises an end coupling portion 42, which is preferably hook-shaped and surrounds a main part of, or substantially completely, the periphery of the pin coupling seat 12a.

According to an embodiment, the central coupling portion 41 comprises a pair of parallel portions 43 each of which is connected to a respective side coupling portion 17, preferably by means of a respective connection portion 18. According to an embodiment, the parallel portions 43 are symmetric respect to the symmetry plane 16 of the spring 15. According to an embodiment, the parallel portions 43 continue into the end coupling portion 42 and preferably join together by means of an end connection portion 44 which defines an end of the end portion 42.

According to an embodiment, the central spring coupling portion 41 and the pin coupling seat 12a are configured to maintain the central spring coupling portion 41 in a fixed or substantially fixed position in the pin coupling seat 12a. In particular, according to an embodiment, the central coupling portion 41 is fitted onto the coupling seat 12a.

According to an embodiment, the pin coupling seat 12a is a recessed pin portion delimited in the axial direction A-A by a pair of opposite shoulders 12b. In particular, according to an embodiment, the coupling seat 12a comprises a reduced-section or reduced-diameter portion of the pin 12. At least one part of the central spring coupling portion 41 is received in the aforesaid recessed pin portion so as to be interposed between the opposite shoulders 12b so as to prevent or substantially prevent the central spring coupling portion 41 from sliding in the axial direction A-A along the pad guide pin 12.

According to an embodiment, in a section of the plate coupling portion 37 according to a plane containing the axial direction A-A and the radial direction R-R, each plate coupling portion 37 comprises:
an inner lower edge 25 adapted to face the brake disc 4 in the radially inward direction or towards the disc rotation axis 10;
an inner upper edge 26 adapted to face the brake disc 4 in the radially outward direction or opposite to the rotation axis of the brake disc 10.

According to an embodiment, the inner upper edge 26 is radially arranged on the side opposite to the inner lower edge 25.

According to an embodiment, the inner upper edge 26 continues in an upper surface 27 directed according to an axial direction A-A parallel to the rotation axis of the disc 10, forming an upper edge 29 of coupling portion of the plate to the spring.

In particular, according to an embodiment, each side spring coupling portion 17 is always in contact with:
the inner lower edge 25; and
the upper edge 29 of coupling portion of the plate to the spring.

More in particular, according to an embodiment, each side spring coupling portion 17 is always in contact with:
the inner lower edge 25; and
the upper edge 29 of coupling portion of the plate to the spring.

According to an embodiment, the upper surface 27 continues in an outer upper edge 28 adapted to face the opposite direction with respect to the brake disc 4.

According to an embodiment, each spring 15 is always in contact with the upper inner edge 26 or the upper surface 27 or the upper outer edge 28.

According to an embodiment, each of the two springs 15 is connected to the ear 7b of a first pad 6 and to the ear 7b of the other pad 6, respectively, either directly or indirectly facing the first pad ear 7b.

According to an embodiment, the at least one plate coupling portion 37 comprises the upper edge 29 of coupling portion of the plate to the spring, an inner side 33 of pad coupling portion, adapted to face, either directly or indirectly, the brake disc 4, and a lower edge 34 of coupling portion of the plate to the spring comprising the inner lower edge 25. The inner upper edge 25 which continues in an upper surface 39 directed according to an axial direction A-A parallel to the rotation axis of the disc 10.

According to an embodiment, the upper edge 29 of coupling portion of the plate to the spring comprises an upper edge spring seat shaped to couple intimately to a side coupling portion or side spring arm 17.

According to an embodiment, the lower edge 34 of coupling portion of the plate to the spring comprises a lower edge spring seat shaped to couple intimately to a side coupling portion or side spring arm 17.

According to an embodiment, the inner pad coupling portion side 33 comprises an inner side spring seat shaped to couple intimately to a side coupling portion or side spring arm 17.

According to an embodiment, observed in a plane containing an axial direction A-A and a radial direction R-R, the at least one spring 15 is substantially “M”-shaped (FIG. 12).

According to an embodiment, the caliper body 3 comprises at least one housing recess 30 which extends in the axial direction A-A and in the radial direction R-R in the caliper body 3 and in which one of the side spring coupling portions 17 is at least partially received. Advantageously, the at least one housing recess 30 allows creating an operating space which facilitates the assembly and operation of the spring 15, while allowing the overall dimensions of the caliper in the axial direction A-A to be kept small.

According to an embodiment, the housing recess 30 is obtained in the second brake caliper portion 3.2. According to an embodiment, the housing recess 30 has a radially outer side 31 open and an opposite radially inner side 32 delimited by a wall 32a of the caliper body 3. According to an embodiment, the at least one part of the side spring coupling portion 17 received in the housing recess 30 is spaced apart from the caliper body 3. In other words, such at least one part of side spring coupling portion 17 received in the housing recess 30 is not in contact or avoids contacting the caliper body 3.

According to an embodiment, the bracket 2 comprises a bracket body 2.1 configured to extend from only one side of the brake disc 4. Advantageously, such a shape and arrangement of the bracket body 2.1 allows reducing the weight and improving the appearance of the caliper 1. Furthermore, the bracket body 2.1 has a geometry which advantageously allows increasing the surface area of the friction material 8 of the pads 6 without excessively penalizing the weight of the caliper 1, as is the case on floating calipers with the bracket arranged straddling the brake disc. Indeed, since the bracket body 2.1 has no side portions which are typically present in the brackets configured to be arranged straddling the brake disc, it is possible to use the corresponding volume to increase the surface of the pad friction material. According to an embodiment, the bracket body 2.1 either comprises or consists of two bracket support arms 2a and a bracket connection portion 2b which connects the bracket support arms 2a. In particular, according to an embodiment, the bracket body 2.1 is substantially “C”-shaped. According to an embodiment, the bracket body 2.1 extends parallel or substantially parallel to a plane orthogonal to the rotation axis 10 of the brake disc 4.

According to an embodiment, the body 2.1 of the bracket 2 is interposed between the pad 6 which is intended to be biased by the thrust means 5a, i.e., the pad 6 arranged axially closer to the first caliper body portion 3.1, and the caliper body sliding guide 11. More in particular, according to an embodiment, the bracket body 2.1 is interposed between the pad guide pin 12 and the caliper body sliding guide 11.

According to an embodiment, the bracket 2 comprises a bracket mounting element 2.3 or bracket mounting hole 2.3, preferably two bracket mounting elements or bracket mounting holes 2.3. The at least one bracket mounting element 2.3 is configured to allow rigidly connecting the bracket 2 to a vehicle suspension by connection means, such as screws or bolts and nuts, for example.

According to an embodiment, the bracket 2 comprises at least one bracket connection portion 2.2. According to an embodiment, the bracket 2 comprises two bracket connection portions 2.2, each provided on a respective bracket support arm 2a. In an embodiment, the at least one bracket connection portion 2.2 delimits a respective bracket connection through-hole or bracket connection channel 2.4 along the axial direction A-A. In an embodiment, the bracket connection through-hole 2.4 extends between a first bracket opening 2.5 and a second bracket opening 2.6. In an embodiment, the first bracket opening 2.5 faces the first caliper body portion 3.1 and the second bracket opening 2.6 faces the opposite side.

According to an embodiment, the pad guide pin 12 is connected and coaxial to the caliper body guide pin 11. Advantageously, the provision of such an integrated system for sliding the pads 6 and guiding the caliper body 3 ensures a reduction in the components and processes required to make the guide systems of pads and caliper body. According to an embodiment, the pad guide pin 12 is reversibly connected to the caliper body guide pin 11.

According to an embodiment, the at least one pad guide pin 12 comprises a coupling end portion 12.1, which passes through the first bracket connection through-hole 2.4 and is reversibly coupled to the caliper body guide pin 11. According to an embodiment, the coupling end portion 12.1 comprises a first segment 12.2 extending into the bracket connection through-hole 2.4, and a second end segment 12.3 extending outside the bracket connection through-hole to couple in a mating coupling seat 11.1 provided in the caliper body guide pin 11. According to an embodiment, the first segment 12.2 extends exclusively into the bracket connection through-hole 2.4. According to an embodiment, the second end segment 12.2 extends exclusively outside the bracket connection through-hole 2.4.

According to an embodiment, the second end segment 12.3 is a threaded segment and the mating coupling seat 11.1 is a threaded coupling seat in which the second end segment 12.3 is screwed. According to an embodiment, the first segment 12.2 and the connection through-hole 2.4 are threadless. In other words, according to an embodiment, the first segment 12.2 and the bracket connection through-hole 2.4 form a coupling of the shaft/hole type with clearance. Advantageously, it is thus possible to prevent the pad pin 12 from unscrewing accidentally when the caliper body guide pin 11 is unscrewed, e.g., if the pads 6 needs to be replaced.

According to an embodiment, the at least one pad guide pin 12 comprises an abutment portion or abutment flange 12.4 which is adapted to abut against the bracket 2 on the side of the second bracket opening 2.6 when the pad guide pin 12 and the caliper body guide pin 11 are coupled together.

According to an embodiment, the caliper body 3 comprises at least one caliper body hole 3.6 arranged facing an end portion 12.5 of the at least one pad guide pin 12 which is opposite to the coupling end portion 12.1. According to an embodiment, the hole 3.6 is adapted to receive the end portion 12.5 following the wear of the pads 6. Indeed, during the wear of the friction material 8 the caliper body 3 retracts and the pad guide pin 12 fits into the hole 3.6. According to an alternative embodiment, the hole 3.6 could accommodate at least one bearing, preferably a self-lubricating bearing. Such a bearing would be adapted to receive and guide a respective pad guide pin 12 so as to increase the stiffness. In this way, the pad guide pin 12, in addition to performing the function of guiding the pads 6, would simultaneously counteract the deformation or twisting of the caliper body 3.

According to an embodiment, the end portion 12.5 of the pad guide pin 12 comprises a manipulation seat 12.6 so that the end portion 12.5 is accessible through the hole 3.6 and is manipulable by a tool insertable through the hole 3.6.

According to an embodiment, the caliper body guide pin 11 comprises an axially inner first end portion 11.2 and an axially outer second end portion 11.3. According to an embodiment, the axially inner first end portion 11.2 is adapted to abut against the bracket 2 on the side of the first bracket opening 2.5 when the pad guide pin 12 and the caliper body guide pin 11 are coupled together. According to an embodiment, the axially inner end portion 11.2 comprises a mating coupling seat 11.1.

According to an alternative embodiment (not shown), the pad guide pin 12 and the caliper body sliding pin 11 can be made in one piece. In this case, the pad guide pin 12 and the caliper body sliding pin 11 will correspond, respectively, to a pad guide portion 12 and a caliper body sliding portion of a single pin 11,12 having both the functions of pad sliding guide and caliper body sliding guide.

According to an embodiment, the axially outer second end portion 11.3 of the caliper body guide pin 11 comprises a manipulation seat 11.4 so that the end portion 11.3 is manipulable by a user and/or tool to couple and decouple the caliper body guide pin 11 to/from the pad guide pin 12.

According to an embodiment, the caliper body guide pin 11 comprises a pin sliding portion 11.5. The pin sliding portion 11.5 is slidingly housed in a respective sliding seat 3.5 which is obtained in the caliper body 3. According to an embodiment, the pin sliding portion 11.5 slides with respect to the sliding seat 3.5 directly in contact with the latter.

According to an embodiment, the brake caliper 1 comprises at least one dust sleeve 50,51 associated with the at least one caliper body guide pin 11. According to an embodiment, the brake caliper 1 comprises a first and a second dust sleeve 50,51 associated with the at least one caliper body guide pin 11.

According to an embodiment, each dust sleeve 50,51 is configured to prevent liquids and dust from entering into the sliding seat 3.5 and prevent liquids and dust from contacting the guide sliding portion 11.5.

According to an embodiment, each dust sleeve 50,51 comprises an extendable portion, e.g., a bellows-like portion, configured to elastically adapt to the sliding of the caliper body 3 with respect to the bracket 2.

According to an embodiment, the first sleeve 50 is fitted onto the end portion 11.3 of the guide pin 11 and is preferably engaged in appropriate coupling seats provided in the portion 11.3 and in the sliding seat 3.5.

According to an embodiment, the second sleeve 51 is fitted onto the end portion 11.2 of the guide pin 11 and is preferably coupled in appropriate additional coupling seats provided in the portion 11.2 and in the sliding seat 3.5.

Based on the above description, it is thus possible to understand how a floating brake caliper according to the present invention allows achieving the objects mentioned above with reference to the prior art. Without prejudice to the principle of the invention, the embodiments and the constructional details may be broadly varied relative to the above description merely disclosed by way of a non-limiting example, without departing from the scope of the invention as defined in the appended claims.

1. A brake caliper (1) of the floating type of a disc brake (100) comprising:
a bracket or support element (2) configured to be connected to a vehicle,
a caliper body or floating element (3),
wherein the caliper body (3) comprises a first caliper body portion or caliper body vehicle-side portion (3.1), wherein the first caliper body portion (3.1) delimits at least one housing seat (5) for thrust means (5a);
wherein the caliper body (3) comprises a second caliper body portion or cantilevered caliper body portion (3.2), wherein the second caliper body portion (3.2) projects from the first caliper body portion (3.1) at least in the axial direction (A-A);
at least one caliper body sliding guide or caliper body guide pin (11), wherein said at least one caliper body sliding guide (11) is arranged between said caliper body (3) and said bracket (2) to allow a relative sliding between said caliper body (3) and said bracket (2) along an axial direction (A-A);
at least two pads (6) having a support plate (7) and a friction material lining (8), each of said at least two pads (6) being positionable on a side of a brake disc (4) of said disc brake (100) facing opposite braking surfaces (4a) of a braking band (4b) of the brake disc (4);
said brake disc (4) being a rotor adapted to rotate about a rotation axis (10) which defines said axial direction (A-A), parallel to said rotation axis (10), a radial direction (R-R), orthogonal to said rotation axis (10), and a circumferential direction (C-C) orthogonal to said radial (R-R) and axial (A-A) directions;
at least one pad guide pin (12) supported by said bracket (2) and which extends in the axial direction (A-A), said pads (6) being slidingly mounted to said pad guide pin (12) so as to allow said pads (6) to slide in the axial direction (A-A) along said pad guide pin (12);
at least one spring (15), shaped to be arranged straddling the brake disc (4), wherein said spring (15) applies an elastic bias to said pads (6) so as to elastically bias the pads (6) away from the brake disc (4) and so as to cause, by means of at least one of said pads (6), the caliper body (3) to slide in said axial direction (A-A), in the direction in which the second caliper body portion (3.2) moves away from the brake disc (4);
wherein said spring (15) is also connected to said pad guide pin (12) in addition to being connected to said pads (6).

2. A brake caliper (1) according to claim 1, wherein the pad guide pin (12) comprises a pin coupling seat (12a) to which said spring (15) is connected, said pin coupling seat (12a) being located at a predetermined pad guide pin portion (12) intended to be either aligned or substantially aligned with a centerline plane (4c) of said braking band (4b) which is orthogonal to said axial direction (A-A).

3. A brake caliper (1) according to claim 1, wherein said spring (15) defines a spring symmetry plane (16) and either comprises or consists of two side spring coupling portions or lateral spring arms (17) and a central spring coupling portion or central spring arm (41), which is interposed between, and connected to, said side spring coupling portions (17), wherein said side spring coupling portions (17) are symmetrical with respect to the spring symmetry plane (16) and are configured to couple to two respective opposite plate coupling portions (37) of said pads (6), wherein said central spring coupling portion (41) is configured to couple to said pin coupling seat (12a);
and/or wherein
said central spring coupling portion (41) extends either mainly or entirely along a direction parallel to said spring symmetry plane (16).

4. A brake caliper (1) according to claim 3, wherein said central spring coupling portion (41) and said pin coupling seat (12a) are configured to maintain the central spring coupling portion (41) in a fixed or substantially fixed position in said pin coupling seat (12a).

5. A brake caliper (1) according to claim 3, wherein said pin coupling seat (12a) is a recessed pin portion delimited in the axial direction (A-A) by a pair of opposite shoulders (12b), wherein at least one part of said central spring coupling portion (41) is received in said recessed pin portion so as to be interposed between said opposite shoulders (12b) so as to prevent or substantially prevent said central spring coupling portion (41) from sliding in the axial direction (A-A) along the pad guide pin (12).

6. A brake caliper (1) according to claim 3, wherein said central spring coupling portion (41) comprises an end coupling portion (42) which is hook-shaped and surrounds a main portion of, or substantially completely, the periphery of said pin coupling seat (12a).

7. A brake caliper (1) according to claim 1, wherein said spring (15) is exclusively connected to said pads (6) and said pad guide pin (12).

8. A brake caliper (1) according to claim 3, wherein the caliper body (3) which comprises at least one housing recess (30) extending in the axial direction (A-A) and in the radial direction (R-R) in the caliper body (3) and in which one of said side spring coupling portions (17) is at least partially received,
and/or wherein
said housing recess (30) has a radially open outer side (31) and an opposite radially inner side (32) delimited by a wall (32a) of the caliper body (3);
and/or wherein
said at least one spring coupling side portion part (17) received in said housing recess (30) is spaced apart from the caliper body (3).

9. A brake caliper (1) according to claim 3, wherein in a section of the plate coupling portion (37) according to a plane which contains the axial direction (A-A) and the radial direction (R-R), each of said plate coupling portions (37) comprises:
an inner lower edge (25) adapted to face the brake disc (4) in the radially inward direction or towards the disc rotation axis (10);
an inner upper edge (26) adapted to face the brake disc (4) in the radially outward direction or opposite to the brake disc rotation axis (10);
said inner upper edge (26) continues in an upper surface (27) directed according to an axial direction (A-A) parallel to said rotation axis of the disc (10), forming an upper edge (29) of coupling portion of the plate to the spring;
and wherein each side spring coupling portion (17) is always in contact with:
said inner lower edge (25)
and
said upper edge (29) of coupling portion of the plate to the spring.

10. A brake caliper (1) according to claim 1, wherein said spring (15) is a one-piece wire spring;
and/or wherein
wherein said spring (15) is a wire spring having a circular or rectangular section.

11. A brake caliper (1) according to claim 1, wherein said bracket (2) comprises a bracket body (2.1) configured to extend from only one side of said brake disc (4) and which is interposed between the pad (6) which is intended to be biased by said thrust means (5a) and said caliper body sliding guide (11);
and/or wherein
said bracket body (2.1) is interposed between said pad guide pin (12) and said caliper body sliding guide (11);
and/or wherein
said bracket body (2.1) either comprises or consists of two bracket support arms (2a) and a bracket connection portion (2b) which connects said bracket support arms (2a);
and/or wherein
said bracket body (2.1) is substantially “C”-shaped.

12. A brake caliper (1) according to claim 1, wherein said pad guide pin (12) is connected and coaxial to said caliper body guide pin (11).

13. A brake caliper (1) according to claim 12, wherein the bracket (2) comprises at least one bracket connection portion (2.2) which delimits a respective bracket connection through-hole or bracket connection channel (2.4) along the axial direction (A-A), wherein the at least a first pad guide pin (12) comprises a coupling end portion (12.1) which crosses said bracket connection through-hole (2.4) and is reversibly coupled to the caliper body guide pin (11), wherein said coupling end portion (12.1) comprises a first segment (12.2) extending into said bracket connection through-hole (2.4) and a second end segment (12.3) extending outside the bracket connection through-hole to couple in a mating coupling seat (11.1) provided in the caliper body guide pin (11).

14. A brake caliper (1) according to claim 1,
wherein said second caliper body portion (3.2) comprises a first part (3a), a second part (3b) and a third part (3c) of the second caliper body portion (3.2), wherein the first part (3a) of the second caliper body portion (3.2) is opposed to and spaced apart in the axial direction (A-A) from said first caliper body portion (3.1), wherein said second and third parts (3b,3c) of the second caliper body portion (3.2) are opposed to each other and extend at least in the axial direction (A-A) to connect the first caliper body portion (3.1) and the first part (3a) of the second caliper body portion (3.2),
wherein said first caliper body portion (3.1) and said first part (3a), second part (3b), and third part (3c) of the second caliper body portion (3.2) are joined together to form a closed ring extending around or delimiting a housing space (3.3) of said pads (6);
and/or wherein
said second caliper body portion (3.2) comprises a bridge-like connection portion (3d) which connects the first caliper body portion (3.1) and the first part (3a) of the second caliper body portion (3.2) so that the caliper body (3) is adapted to be arranged straddling said brake disc (4);
or wherein
said second caliper body portion (3.2) comprises a first part (3a) of the second caliper body portion (3.2) which is opposed to and spaced apart in the axial direction (A-A) from said first caliper body portion (3.1), wherein said second caliper body portion (3.2) comprises a bridge-like connection portion (3d) which connects the first caliper body portion (3.1) and the first part (3a) of the second caliper body portion (3.2) so that the caliper body (3) is adapted to be arranged straddling said brake disc (4);
and/or wherein
said first part (3a) of the second caliper body portion (3.2) comprises at least one processing through-opening (3.4) arranged facing said at least one housing seat (5) for said thrust means (5a), which is configured to be crossed by a tool for processing the inner surface of said housing seat (5) for said thrust means (5a).

15. A disc brake (100) comprising a caliper (1) according to claim 1.
